(19) United States
(12) Patent Application Publication
(10) Pub. No.: US 2003/0193458 A1
(43) Pub. Date: Oct. 16, 2003

(54) System and method for providing voltages for a liquid crystal display

(76) Inventor: Terence R. Klein, Averill Park, NY (US)

Correspondence Address: BAKER BOTTS, LLP, 910 LOUISIANA, HOUSTON, TX, 77002-4995, US

(21) Appl. No.: 10/123,512

(22) Filed: Apr. 16, 2002

(51) Int. Cl. G09G 3/36

(52) U.S. Cl. 345/87

(57) ABSTRACT

A digital-to-analog converter unit is adapted to apply at an output a pixel charging voltage for a liquid crystal display corresponding to a digital signal. A digital-to-analog converter generates a high resolution signal. An offset generator generates an offset voltage according to an inversion signal and an adder adds the offset voltage to the high resolution signal thus providing the pixel charging voltage.

### FIELD OF THE INVENTION

The present invention relates generally to liquid crystal display devices, and more particularly to a digital to analog converter unit for providing a voltage for driving a display screen of a liquid crystal display device pixels with a high resolution.

### BACKGROUND OF THE INVENTION

Liquid crystal displays (LCDs) are commonly used in devices such as portable televisions, portable computers, control displays, and cellular phones to display information to a user. LCDs act in effect as a light valve, i.e., they allow transmission of light in one state, block the transmission of light in a second state, and some include several intermediate stages for partial transmission. When used as a high resolution information display, as in one embodiment of the present application, LCDs are typically arranged in a matrix configuration with independently controlled pixels. Each individual pixel is signaled to selectively transmit or block light from a backlight (transmission mode), from a reflector (reflective mode), or from a combination of the two (transflective mode). An LCD pixel can control the transference for different wavelengths of light. For example, an LCD can have pixels that control the amount of transmission of red, green, and blue light independently. In some LCDs, voltages are applied to different portions of a pixel to control light passing through several portions of dyed glass. In other LCDs, different colors are projected onto the pixel sequentially in time. If the voltage is also changed sequentially in time, different intensities of different colors of light result. By quickly changing the wavelength of light to which the pixel is exposed an observer will see the combination of colors rather than sequential discrete colors. Several monochrome LCDs can also result in a color display. For example, a monochrome red LCD can project its image onto a screen. If a monochrome green and monochrome blue LCD are projected in alignment with the red, the combination will be full color.

The monochrome resolution of an LCD can be defined by the number of different levels of light transmission that each pixel can perform in response to a control signal. A second level is different from a first level when the user can tell the difference between the two. An LCD with greater monochrome resolution will look clearer to the user. LCDs are actuated pixel-by-pixel, either one at a time or several simultaneously. A voltage is applied to each pixel and the liquid crystal responds to the voltage by transmitting a corresponding amount of light. In some LCDs an increase in the actuation voltage decreases transmission, while in others it increases transmission. When multiple colors are involved for each pixel, multiple voltages are applied to the pixel at different positions or times depending upon the LCD. Each voltage controls the transmission of a particular color. For example, one pixel can be actuated to allow only blue light to be transmitted while another allows only green. A greater number of different light levels available for each color results in a much greater number of possible color combination.

Converting a complex digital signal that represents an image or video into voltages to be applied to the pixels of an LCD involves circuitry that can limit the monochrome resolution. The signals necessary to drive a single color of an LCD are both digital and analog. It is digital in that each pixel requires a separate selection signal, but it is analog in that an actual voltage is applied to the pixel to determine light transmission. The conversion from a bit-representation of the desired light transmission, as communicated in the image or video signal, to an actual voltage that controls the light transmission can introduce errors that reduce the monochrome resolution of the LCD. In addition liquid crystal displays need the so-called inversion technique to counter effects on the liquid crystal due to DC voltages applied to the pixels. This technique avoids on average any kind of DC applied to the liquid crystal of a pixel.

The video inputs to the LCD are analog signals centered around a center reference voltage of typically from about 6.0 to 8.0 volts. This center reference voltage is not a supply or signal from anywhere, rather it is a mathematical entity. Nearly the same as the center reference voltage is a voltage called “VCOM,” which connects to the LCD cover glass electrode, which is a transparent conductive coating on the inside face (liquid crystal side) of the cover glass. This transparent conductive coating is typically Indium Tin Oxide (ITO).

One frame of video pixels are run at voltages above the center reference voltage (positive inversion) and for the next frame the video pixels are run at voltages below the center reference voltage (negative inversion). Alternating between positive and negative inversions results in a zero net DC bias at each pixel.

A Digital-to-Analog Converter (DAC) suitable for LCDs is a 10-bit converter that takes as an input a bit-representation of voltage that includes 1024 voltage levels and outputs, for example, voltages between 0 and 14 volts, the ideal output levels would therefore differ by 13.7 millivolts (mV). However, this resolution is too coarse for high definition TV signals (HDTV). HDTV signals preferably require a resolution of, e.g. 5 mV. A video signal used in HDTV signals in combination with frame inversion requires the full range of 0-16 V to cover the areas for non-inversion and inversion and therefore the resolution of a 10-bit Digital-to Analog Converter is not satisfactory. It is thus an object of the present invention to provide a Digital-to-Analog Converter unit that comprises an improved resolution in particular for video signals using the inversion technique.

### SUMMARY OF THE INVENTION

The embodiments of the present application are directed to a digital-to-analog converter unit which is adapted to apply at an output a pixel charging voltage for a liquid crystal display corresponding to a digital signal. A digital-to-analog converter generates a high resolution signal. An offset generator generates an offset voltage according to an inversion signal and an adder adds the offset voltage to the high resolution signal thus providing the pixel charging voltage.

Another embodiment comprises a system for actuating a liquid crystal display (LCD), comprising:

(a) a matrix of liquid crystal pixels;

(b) a digital-to-analog converter unit adapted to apply at an output a pixel charging voltage corresponding to a digital signal received at an input and coupled to the matrix to apply the pixel charging voltage to at least one pixel, wherein the digital-to analog converter comprises an offset generator for generating an offset to the pixel charging voltage.

The offset voltage can be generated by an offset current source. The digital-to-analog converter can generate a high resolution current to which an offset current is added. The combined current is then converted into a high resolution pixel charging voltage. In another embodiment, the digital-to-analog converter generates a output voltage to which an offset voltage is added. Yet another embodiment can combine any of the above techniques.

A method of generating a pixel charging voltage, comprising the steps of:

providing a matrix of liquid crystal pixels;

during non inversion of the pixel charging voltage:

generating a first offset voltage;

adding a high resolution pixel charging voltage to the first offset voltage; and

applying the combined voltage to a pixel;

during inversion of the pixel charging voltage:

generating a second offset voltage;

adding a high resolution pixel charging voltage to the second offset voltage; and

applying the combined voltage to a pixel.

Other technical advantages of the present disclosure will be readily apparent to one skilled in the art from the following figures, descriptions, and claims. Various embodiments of the present application obtain only a subset of the advantages set forth. No one advantage is critical to the embodiments.

### BRIEF DESCRIPTION OF THE DRAWINGS

A more complete understanding of the present disclosure and advantages thereof may be acquired by referring to the following description taken in conjunction with the accompanying drawings, in which like reference numbers indicate like features, and wherein:

FIG. 1 is a block diagram showing a LCD with respective control and driver circuitry;

FIG. 2 is another circuit diagram showing the circuits around a pixel of FIG. 1 in more detail;

FIG. 3 is a block diagram of a LCD using the inversion technique;

FIG. 4 is a first embodiment of a digital-to-analog converter unit according to the present invention;

FIG. 5 is a second embodiment of a digital-to-analog converter unit according to the present invention;

FIG. 6 is a third embodiment of a digital-to-analog converter unit according to the present invention;

FIG. 7 is diagram showing a typical video signal using the inversion technique; and

FIG. 8 is a fourth embodiment of a digital-to-analog converter unit according to the present invention.

### DETAILED DESCRIPTION OF THE PREFERRED EMBODIMENTS

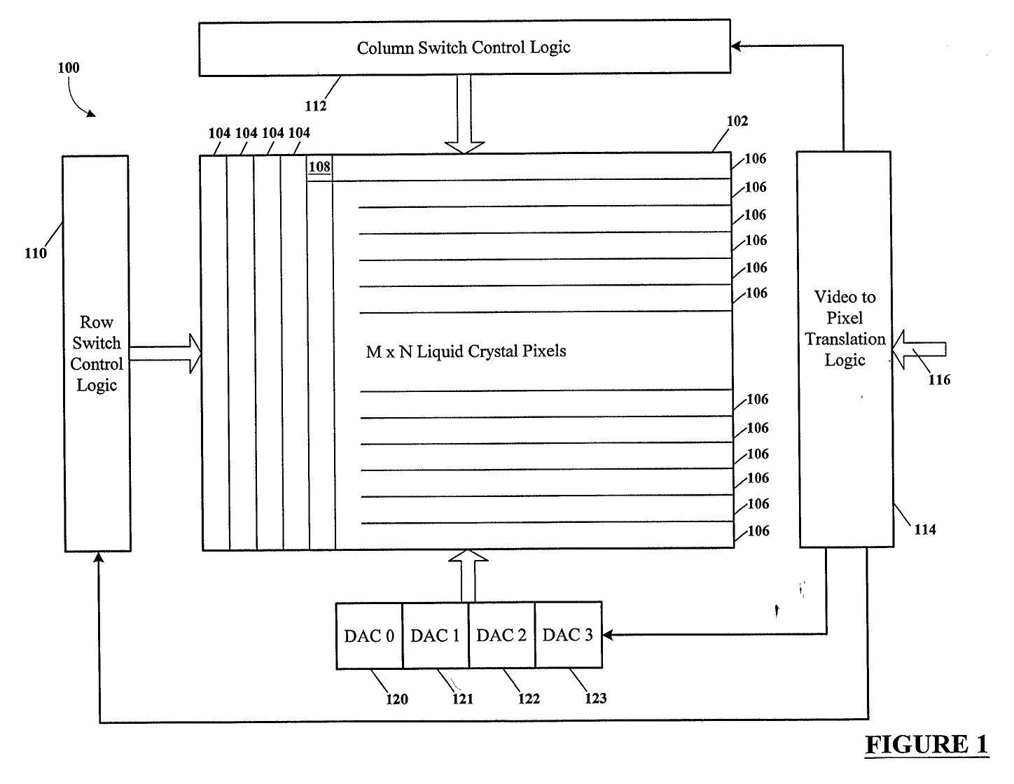

Turning to the drawings, exemplary embodiments of the present application will now be described. Referring to FIG. 1, depicted is a schematic plan view of a liquid crystal display (LCD) arrangement 100. The LCD is generally represented by the numeral 102 and comprises a plurality of pixels 108. Each pixel 108 has a respective pixel capacitor plate or “mirror.” The pixels 108 are arranged in a matrix array including rows 106 and columns 104. In an exemplary embodiment of the invention, pixel mirrors are disposed on a silicon substrate. A pixel mirror forms one plate of a pixel capacitor, the other pixel capacitor plate is formed by a transparent indium tin oxide (ITO) layer. The substrate may be a semiconductor integrated circuit die having transistors fabricated therein and some of these transistors may be connected to the pixel mirrors. A video to pixel translation logic 114 receives a video stream 116. The video to pixel translation logic generates appropriate signals for a column switch control logic 112 and a row switch control logic 110 as well as for a plurality of digital-to-analog converters 123. Column switch control logic selects one or more columns 104 addressed by the video stream and row switch control logic 110 selects a respective row 106. In this shown embodiment four separate digital-to-analog converters 123 are implemented for providing pixel voltages for four columns in parallel. The voltage values being written to the pixels are representative of a frame of video data. The voltage values control the “twist” of the liquid crystal material at each pixel area so that when a light is flashed on or through the LCD, the light polarization and ultimately the intensity of the light passing through a polarization filter is controlled by the “twist” of the liquid crystal material at each pixel area of the LCD.

For illustrative and exemplary purposes, the LCD 100 depicted in FIG. 1 comprises a pixel matrix 102 of M rows 106 by N columns 104 for a total of M×N individually addressable pixels 108. The combination of row control logic 110 and column control logic 112 are used to select each of the pixels 108 for writing thereto in the LCD 100. The digital values are sent to digital-to-analog converters (DACs) 120, 121, 122 and 123, and the pixel location addresses thereof are sent to the row and column control logic 110 and 112.

It is contemplated and within the scope of the present invention that any number of DACs may be used according to exemplary embodiments of the present invention. The DACs 120, 121, 122 and 123 have outputs comprising analog values, e.g., voltage or current, corresponding to digital input words from the translation logic 114.

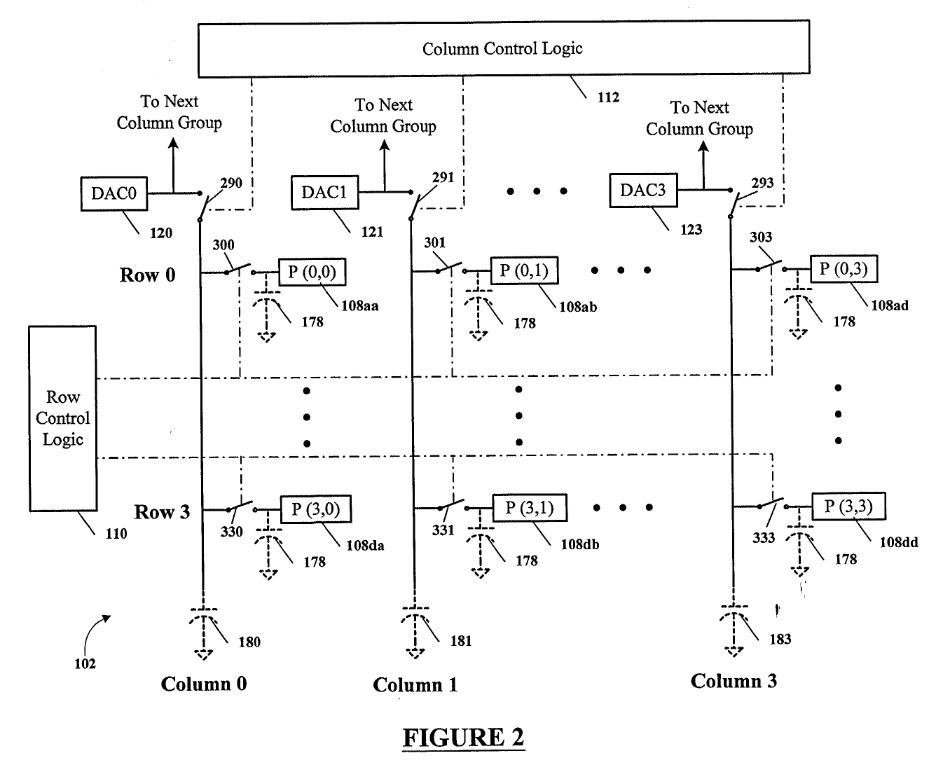

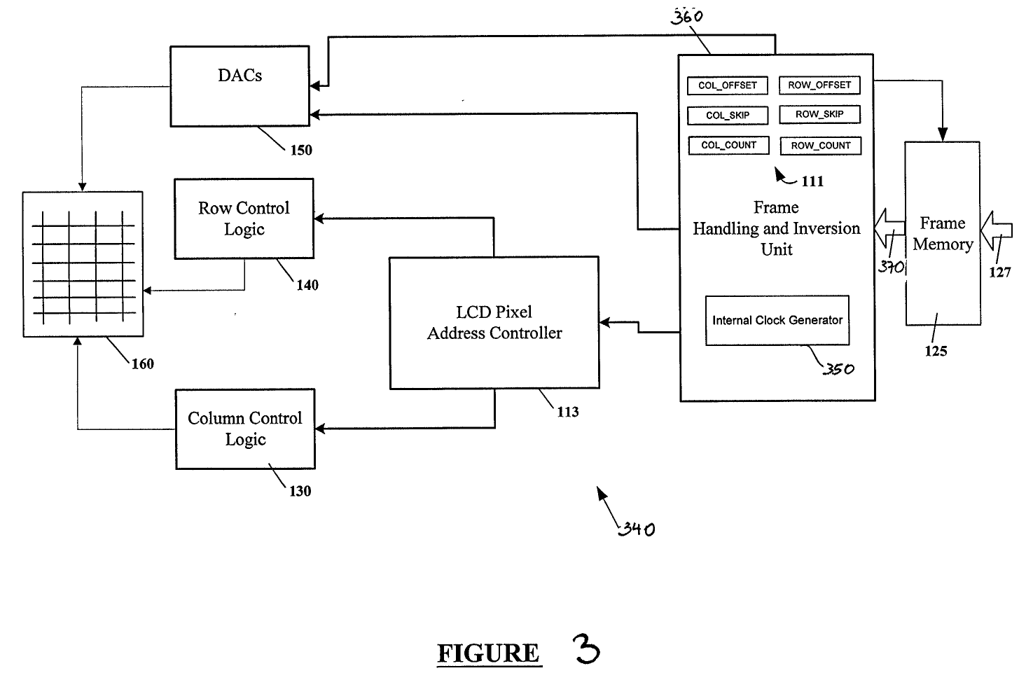

Referring now to FIG. 2, depicted is a schematic block diagram of a portion of the liquid crystal display system 100 of FIG. 1 showing the circuits around a pixel of the LCD in more detail. A portion of the pixel matrix 102 is represented for illustrative and exemplary purposes as pixels 108aa-108dd (4×4 matrix), pixel row switches 300 through 333 and pixel column switches 290 through 293. An LCD operates by placing a desired voltage charge at each pixel 108aa-108dd of the LCD 100. A voltage charge at a pixel 108 causes liquid crystals at that pixel area to change their “twist” orientation so that light passing through the LCD 100 or being reflected is thereby affected. The translation logic 114 uses the received video frame information 116 to create appropriate digital values that are sent to the DACs 120-123 which are representative of that portion of the video frame at each one of the pixel locations. In addition, the translation logic 114 associates an x-y coordinate (row-column) location for each of these pixel voltage values and sends same to the row control logic 110 and column control logic 112.

The DACs 120-123 receive digital representations of video pixel values from the translation logic 114 and convert these digital representations to analog values, e.g., voltage or current, which must then be applied to each corresponding column 104. Each of the pixels 108aa-108dd has a capacitance 178 associated therewith, and each of the columns 0, 1, 2 (not illustrated) and 3 has a capacitance 180, 181, 182 (not illustrated) and 183, respectively, associated therewith. The capacitance 178 of each pixel may not all be the same, nor may the capacitance 180, 181, 182 and 183 of each column be the same. However, a column capacitance, e.g., 180 is greater than a pixel capacitance, e.g., 178. The column capacitance is charged to a desired voltage value. The output of the DAC is connected to the column and thereby charges the column capacitance to a desired analog voltage, each pixel in a selected row is connected to a corresponding column. Therefore, the voltage on the pixel will be substantially the same as the voltage on the corresponding column.

For example, a column(s) is charged to a certain voltage while a pixel row is selected so that the intersection(s) thereof is the desired pixel to be charged. For example, columns 0-3 are charged from the DACs 120-123, respectively, when the column switches 290-293 are closed. The capacitance 178 of each of the pixels 108aa-108dd are charged from the columns 0-3, respectively, when the row switches 300-303 are closed. A plurality of DACs may be used to simultaneously charge the capacitance of a like number of columns, then a like number of switches in a row may be used to charge the capacitance of a like number of pixels from the respective charged columns. The column control logic 112 and row control logic 110 control operation of the column switches 290-293 and row switches 300-333, respectively, for the group of pixels 108aa-108dd. Other pixel groups 108 are controlled in a similar fashion.

Referring now to FIG. 3, a schematic block diagram of an exemplary embodiment of the invention is depicted. A video frame stream 127 is fed to a frame memory 125 which is coupled to a frame handling and inversion unit 360. Frame handling and inversion unit 360 can comprise a plurality of registers 111. Thus, the system is programmable in its control functions. For example, a column offset and a row offset register for controlling a column offset can be provided. Furthermore, registers for controlling a column and/or row skip function can be included in the input video stream handling unit. Those registers can control where and how much of an image is to be displayed on the display 160. Registers for determining an actual offset on the display are depicted in FIG. 3 as registers COL_OFFSET and ROW_OFFSET. The skip registers COL_SKIP, ROW_SKIP determine a predefined amount of columns and rows to be skipped. The count registers COL_COUNT and ROW_COUNT define the column and row number that have to be reached for the defined display. A plurality of other registers can be included in the input video stream handling unit as well as in other control units of the display system 340.

Pixel address information is sent to a LCD pixel address controller 113 which is adapted to control the row control logic 140 and column control logic 130. Frame handling and inversion unit 360 furthermore provides additional control signals to control the DACs 150.

The video information 127 is received by LCD driver system 340. A driver system 340 can be provided for each color (red, green, blue) for which there is video information 370. The driver electronics then provides those pixel charging voltages and control signals to the liquid crystal display 160. Each pixel-charging voltage corresponds to one pixel of one image. Frame handling and inversion unit 360 also manages the frame inversion to avoid any DC voltages in each pixel charging voltage. To this end, frame handling and inversion unit 360 can control the DAC unit 150 to generate the respective charge voltage, for example, by providing a special signal indicating an inversion. The inversion can be controlled for single pixels or frames depending on the respective control signals for the LCD 160.

The liquid crystal display 160 receives these voltages to individual pixels and, in some embodiments, for particular colors for each pixel. The liquid crystal display 160 is adapted to select pixels of which voltages are applied in accordance with received control signals. The voltages change the light transfer characteristics of the pixels. The collective visual impact of the selectively lighted pixels portrays an image.

The driver system 110 can be integrated into an ASIC design. The handling of the video frames is of particular interest according to this application. As mentioned above, any DC component should be avoided to prevent deterioration of the LCD. To this end, for example, single frames are buffered in frame memory 125 and read out to be displayed on LCD 160.

FIG. 4 shows a first exemplary embodiment of a digital-to-analog converter unit 400 suitable to increase the resolution for a pixel signal within a LCD by maintaining the use of a 10-Bit digital-to-analog converter. The converter unit 400 shown in FIG. 4 comprises a 10-Bit digital-to-analog converter 410 generating an output current I₁ which is fed to the non-inverting input of an operational amplifier 450. The non-inverting input is also coupled through a resistor 460 with ground. Two or more current sources 420, 430 are provided and selectively coupled with the non-inverting input of operational amplifier 450 through a select switch 440. A resistor 180 is coupled between the output of operational amplifier 450 and its inverting input which is further coupled through resistor 470 with ground. The output voltage of operational amplifier 450 is fed to terminal 190.

This exemplary embodiment generates an offset voltage as a base from which the digital-to-analog converter 410 adds a voltage which is higher in its resolution because it is limited to a narrower voltage range. For example, the output of the digital-to-analog converter can be limited to Vₒᵤₜ=0-5V. Thus, the output voltage at terminal 490 will be V_{offset}+Vₒᵤₜ. As Vₒᵤₜ is now limited to a narrower voltage range the resolution will be 5V/1024=4.9 mV steps. Again digital-to-analog converter 410 generates a first output current I₁. At the non-inverting input of operational amplifier 450 a second current I₂ is added. This >second current I₂ is selected from one of the current sources 420 and 430 by switch 440. Operational amplifier 450 converts the current I₁+I₂ into a voltage which can be accessed at terminal 490.

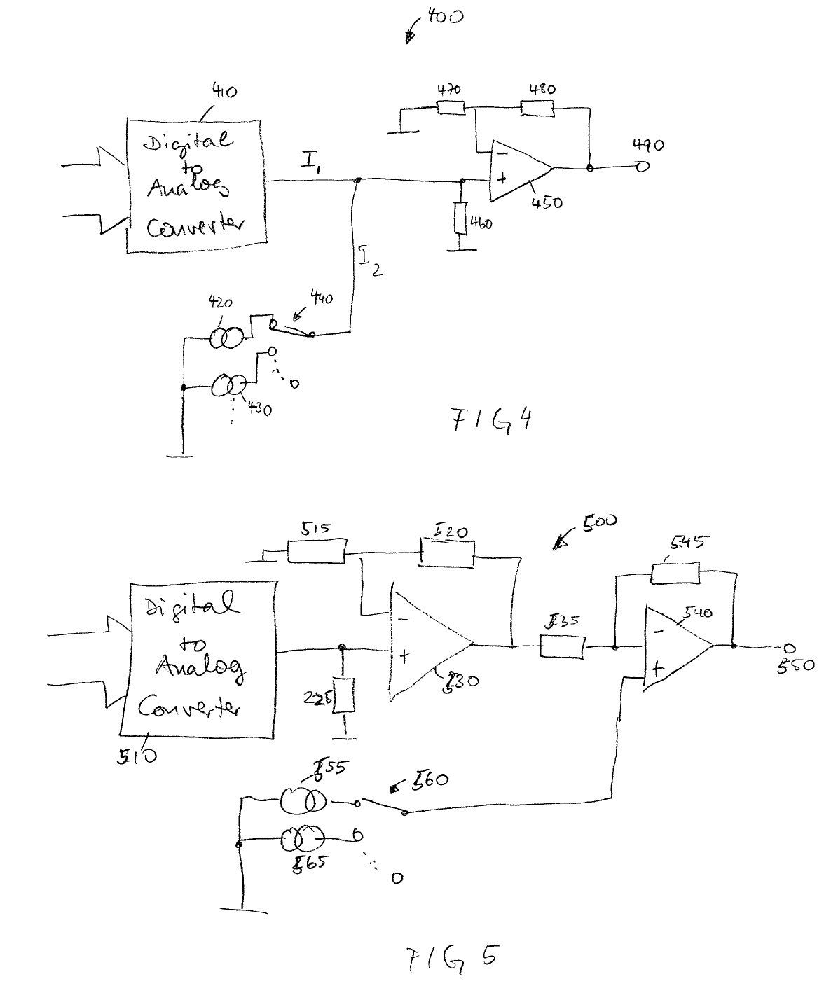

FIG. 5 shows a second exemplary embodiment for a digital-to-analog converter unit 500. A digital-to-analog converter 510 generates a output current I₁ which is fed to the non-inverting input of an operational amplifier 530. A resistor is coupled between ground and the non-inverting input of operational amplifier 530. Another resistor 520 is coupled between the inverting input and the output of operational amplifier 530. The inverting input of operational amplifier 530 is coupled with ground through resistor 515. The output of operational amplifier 530 is coupled through a resistor 535 with the inverting input of operational amplifier 540. Another feedback resistor 545 is coupled between the output and the inverting input of operational amplifier 540. The non-inverting input of operational amplifier 540 is coupled with a switch 560 which selects one of a plurality of current sources 555, 565. A terminal 550 is coupled with the output of operational amplifier 540 to provide the pixel voltage.

In this embodiment the output current of digital-to analog converter 510 is first converted into a voltage and added to a second voltage generated by current sources 555, 565 in combination with current to voltage converter 540, 545. The resulting output voltage can be accessed at terminal 550.

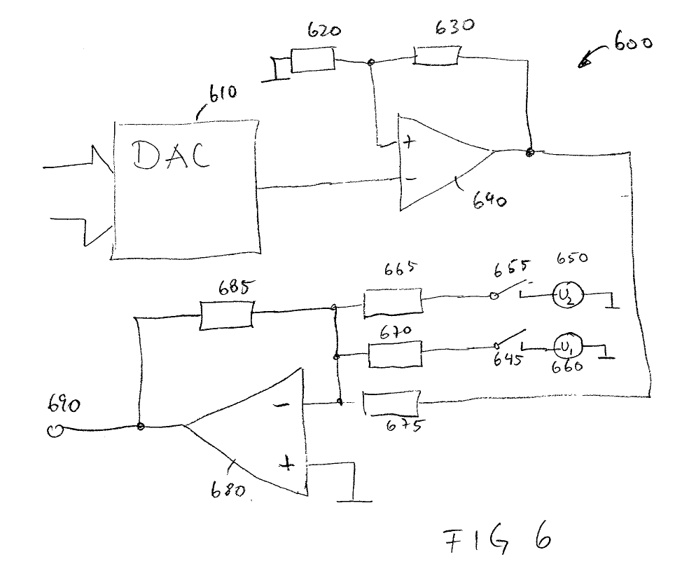

FIG. 6 shows yet another exemplary embodiment of the present invention. The digital-to-analog converter unit 600 again comprises a digital-to analog converter 610 whose output current is fed the inverting input of operational amplifier 640. A feedback resistor 630 is coupled between the output and the non-inverting input of operational amplifier 640. A resistor 520 is coupled between ground and the non-inverting input of operational amplifier 640. The output of operational amplifier 640 is coupled through resistor 675 with the inverting input of operational amplifier 680 whose non-inverting input is coupled with ground. A feedback resistor is coupled between the output of the operational amplifier 680 and its inverting input. Two voltage sources 650, 660 are selectively coupled with the inverting input of operational amplifier 680 through switches 645, 655 and resistors 665, 670, respectively. At terminal 690 the output voltage can be accessed.

This arrangement converts the output current of digital-to analog converter 610 through operational amplifier 640 into a voltage. Operational amplifier 680 operates as an analog adder, adding the respectively selected voltages from voltage sources 650 or 660 to the output voltage of digital-to-analog converter 610.

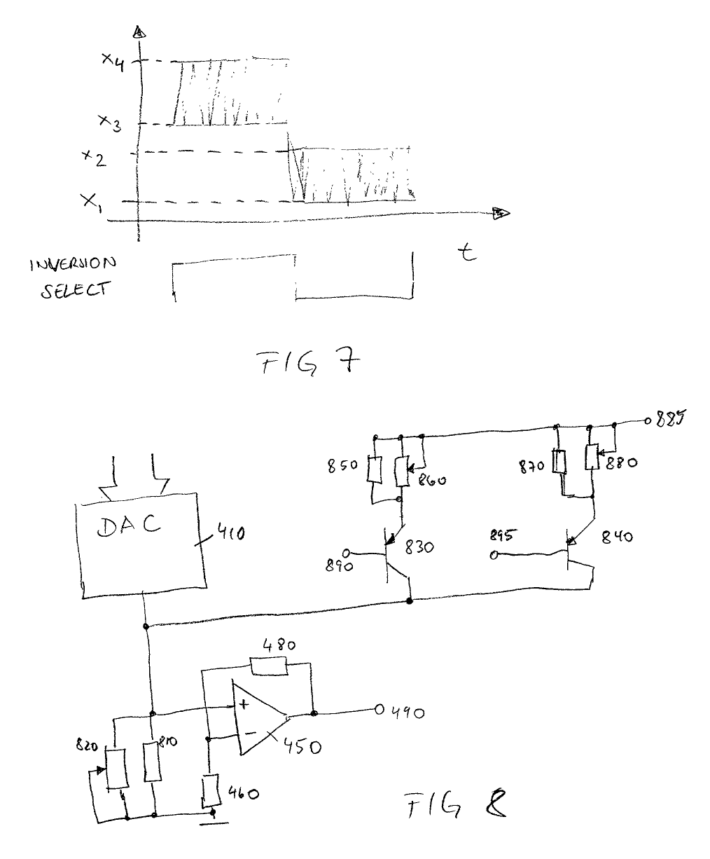

FIG. 7 shows an example of a respective pixel voltage. The pixel voltage fluctuates during a first period within a limited voltage range defined by values X₃ and X₄. The inversion select signal shown at the bottom of the timing diagram indicates whether signal inversion takes place or not. In case this signal turns to a logical zero the inversion is active and the pixel signal now fluctuates between another limited voltage range defined by values X₁ and X₂. Thus the digital-to-analog converter units shown in FIGS. 4-6 generate the respective offset voltages through the offset current sources or the offset voltage sources, respectively. For example, during the first period shown in FIG. 7 select switch selects current source 420 to generate a current I₂ that will be converted into a voltage value of X₃. Thus, the “base voltage” or “zero”-point of digital-to-analog converter 410 is shifted to X₃. Any generated voltage step will now be added to this “base voltage”. Therefore, a much higher resolution, namely almost factor 3, can be achieved maintaining the use of a 10-bit digital-to-analog converter.

FIG. 8 shows yet another implementation of the embodiment shown in FIG. 4. Similar elements are designated by similar numerals. Resistor 470 is here replaced by parallel coupled resistors 810 and 820. Resistor 820 is adjustable. Current source 420 is implemented by a bipolar transistor 830 whose emitter is coupled through parallel coupled resistors 850 and 860 with the supply voltage terminal 885. The base of transistor 830 is coupled with terminal 890 which provides a select or activation signal and the collector of transistor 830 provides the output current. The second current is formed in a similar way by transistor 840, terminal 895 and resistors 870 and 880. Resistors 860 and 870 are adjustable to be able to fine-tune the circuit.

While the present embodiments are susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims. For example, more or less current or voltage sources can be implemented to adapt to the different LCDs. The digital-to-analog converters can generate output signals as described above or generate output signals which have positive and negative signs. thus, the offset voltage would rather be the center voltage, for example, the center value between X₁ and X₂ or between X₃ and X₄ in FIG. 7, respectively.

What is claimed is:

1. A system for actuating a liquid crystal display (LCD), comprising:
(a) a matrix of liquid crystal pixels;
(b) a digital-to-analog converter unit adapted to apply at an output a pixel charging voltage corresponding to a digital signal received at an input and coupled to the matrix to apply the pixel charging voltage to at least one pixel, wherein the digital-to analog converter comprises an offset generator for generating an offset to the pixel charging voltage.

2. A system according to claim 1, wherein the digital-to-analog converter unit comprises a select unit for selecting one of a plurality of offset voltages.

3. A system according to claim 1, wherein the offset voltage is generated by a current.

4. A system according to claim 1, wherein the offset voltage is generated by a voltage.

5. A system according to claim 2, wherein the select unit is controlled by an inversion signal.

6. A system according to claim 3, wherein the digital-to-analog converter unit comprises a digital-to-analog converter generating an output current, a switch for coupling at least one offset current generator with the output of the digital-to-analog converter, and a current to voltage converter coupled with the output of the digital-to-analog converter.

7. A system according to claim 3, wherein the digital-to-analog converter unit comprises a digital-to-analog converter generating an output current, a current to voltage converter coupled with the output of the digital-to-analog converter, a operational amplifier having an inverting and a non-inverting input and an output, a switch for coupling at least one offset current generator with the non-inverting input of the operational amplifier.

8. A system according to claim 3, wherein the digital-to-analog converter unit comprises a digital-to-analog converter generating an output current, a current to voltage converter coupled with the output of the digital-to-analog converter, an controllable offset voltage generator having an input and at least one output, wherein the input is coupled with the output of the current to voltage converter and the output carries the pixel charging voltage signal.

9. A system according to claim 8, wherein the offset voltage generator comprises a plurality of outputs and a select unit for selecting one of the plurality of outputs.

10. A system according to claim 9, wherein the offset voltage generator comprises a tapped resistor chain.

11. Method of generating a pixel charging voltage, comprising the steps of:
providing a matrix of liquid crystal pixels;
during non inversion of the pixel charging voltage:
generating a first offset voltage;
adding a high resolution pixel charging voltage to the first offset voltage; and
applying the combined voltage to a pixel;
during inversion of the pixel charging voltage:
generating a second offset voltage;
adding a high resolution pixel charging voltage to the second offset voltage; and
applying the combined voltage to a pixel.

12. Method according to claim 10, further comprising the step of providing a digital-to-analog converter unit comprises a select unit for selecting one of a plurality of offset voltages.

13. Method according to claim 10, wherein the offset voltage is generated by a current.

14. Method according to claim 11, further comprising the step of controlling the select unit by an inversion signal.

15. Method according to claim 10, further comprising the steps of:
providing a high resolution current;
selecting a first or second offset current;
adding the high resolution current and the selected offset current;
converting the combined current into the pixel charging voltage.

16. Method according to claim 10, further comprising the steps of:
providing a high resolution current;
selecting a first or second offset voltage;
converting the high resolution current into a high resolution voltage, and
adding the high resolution voltage and the selected offset voltage to generate the pixel charging voltage.

17. A digital-to-analog converter unit adapted to apply at an output a pixel charging voltage for a liquid crystal display corresponding to a digital signal comprising a digital-to-analog converter generating a high resolution signal, an offset generator for generating an offset voltage and an adder for adding the offset voltage to the high resolution signal thus providing the pixel charging voltage.

18. Digital-to-analog converter according to claim 16, wherein the digital-to-analog converter unit comprises a select unit for selecting one of a plurality of offset voltages.

19. Digital-to-analog converter according to claim 16, wherein the offset voltage is generated by a current.

20. Digital-to-analog converter according to claim 16, wherein the offset voltage is generated by a voltage.

21. Digital- to-analog converter according to claim 17, wherein the select unit is controlled by an inversion signal.

22. Digital-to-analog converter according to claim 18, wherein the digital-to-analog converter unit comprises a digital-to-analog converter generating an output current, a switch for coupling at least one offset current generator with the output of the digital-to-analog converter, and a current to voltage converter coupled with the output of the digital-to-analog converter.

23. Digital-to-analog converter according to claim 18, wherein the digital-to-analog converter unit comprises a digital-to-analog converter generating an output current, a current to voltage converter coupled with the output of the digital-to-analog converter, a operational amplifier having an inverting and a non-inverting input and an output, a switch for coupling at least one offset current generator with the non-inverting input of the operational amplifier.

24. Digital-to-analog converter according to claim 18, wherein the digital-to-analog converter unit comprises a digital-to-analog converter generating an output current, a current to voltage converter coupled with the output of the digital-to-analog converter, an controllable offset voltage generator having an input and at least one output, wherein the input is coupled with the output of the current to voltage converter and the output carries the pixel charging voltage signal.

25. A system according to claim 23, wherein the offset voltage generator comprises a plurality of outputs and a select unit for selecting one of the plurality of outputs.

26. A system according to claim 24, wherein the offset voltage generator comprises a tapped resistor chain.
